(19) United States
(12) Patent Application Publication
(10) Pub. No.: US 2006/0072752 A1
(43) Pub. Date: Apr. 6, 2006

(54) Broadcast receiving apparatus and broadcast receiving method

(76) Inventors: Hiroyuki Nakano, Ome-shi (JP); Noriya Sakamoto, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,070

(22) Filed: Sep. 27, 2005

(30) Foreign Application Priority Data
Sep. 27, 2004 (JP) 2004-280472

(51) Int. Cl. H04N 7/167

(52) U.S. Cl. 380/239

(57) ABSTRACT

A broadcast receiving apparatus having demodulator for demodulating signal received from the tuner and releasing video and audio signals, first encryption decoder for encrypting or decoding the video and audio signals with the use of first encryption key, recorder for recording the encrypted video and audio signals, second encryption decoder for encrypting or decoding the video and audio signals with the use of second encryption key, communication devices for transmitting the video and audio signals encrypted in the second encryption decoder to another recorder over network, and controllers for, when the video and audio signals are recorded in the recorder, directing the video and audio signals to be encrypted with the first encryption decoder and recorded, and when the video and audio signals are transmitted via the communicator, directing the video and audio signals to be encrypted with the second encryption decoder and transferred.

### CROSS-REFERENCE TO RELATED APPLICATIONS

This application is based upon and claims the benefit of priority from prior Japanese Patent Application No. 2004-280472, filed Sep. 27, 2004, the entire contents of which are incorporated herein by reference.

### BACKGROUND OF THE INVENTION

1. Field of the Invention

The present invention relates to a broadcast receiving apparatus such as a television receiver equipped with a network function and particularly to a broadcast receiving apparatus and a broadcast receiving method where video and audio signals to be exchanged over a network can be improved in the security.

2. Description of the Related Art

As is well known, the television broadcasting systems have been digitized in recent years. In Japan, for example, digital terrestrial broadcasting services are now in their early stages, following digital broadcast satellite (BS) broadcasting services and 110-degree communication satellite (CS) digital broadcasting services.

Such a digital broadcast receiver for receiving the digital television broadcast is arranged to handle a digital form video and audio information and can thus conduct with much ease processes of recording, reproducing, retrieving, and managing contents information as well as utilizing its relevant information of electronic program information. One of the conventional technologies for picking up the information of electronic program information from the digital television broadcast is disclosed in patent document 1 (Jpn. Pat. Appln. KOKAI Publication No. 2002-142163).

However, the technology disclosed in patent document 1 fails to clarify the use of digital contents over a network and takes no measure for protecting the information from being illegally accessed by a third or unauthorized person over the network.

### BRIEF SUMMARY OF THE INVENTION

A broadcast receiving apparatus according to the present invention comprises: a tuner which receives broadcast signals and selectively outputs the received signal; a demodulator which demodulates the received signal outputted from the tuner and outputs video and audio signals; a first encryption decoder which encrypts or decodes the video and audio signals with the use of a first encryption key; a recorder which records the video and audio signals encrypted in the first encryption decoder; a second encryption decoder which encrypts or decodes the video and audio signals with the use of a second encryption key which is different from the first encryption key; a communicator which performs communication to transmit the video and audio signals encrypted in the second encryption decoder to another recorder over a network; and a controller which, when the video and audio signals received from the demodulator or the outside are recorded in the recorder, directs the video and audio signals to be encrypted with the first encryption decoder and recorded, when taken out, decodes the signals in the first encryption decoder to be outputted, and when the video and audio signals are transmitted via the communicator, directs the video and audio signals to be encrypted with the second encryption decoder and transferred to another recorder over the network.

### BRIEF DESCRIPTION OF THE SEVERAL VIEWS OF THE DRAWING

FIG. 1 is a schematic view of a digital television broadcast receiver and a network system constructed with the digital television broadcast receiver at the center, according to one embodiment of the present invention;

FIG. 2 is a block diagram showing a configuration of the digital television broadcast receiver according to one embodiment of the present invention;

FIG. 3 is a block diagram showing a remote controller for the digital television broadcast receiver according to one embodiment of the present invention;

FIG. 4 is a network diagram showing one feature of the digital television broadcast receiver according to one embodiment of the present invention; and

FIG. 5 is a flowchart illustrating a procedure of decoding an encrypted signal in the digital television broadcast receiver according to one embodiment of the present invention.

### DETAILED DESCRIPTION OF THE INVENTION

Embodiments of the present invention will be described in more detail, referring to the relevant drawings.

<Television Receiver Equipped with a Network Function According to the Present Invention>

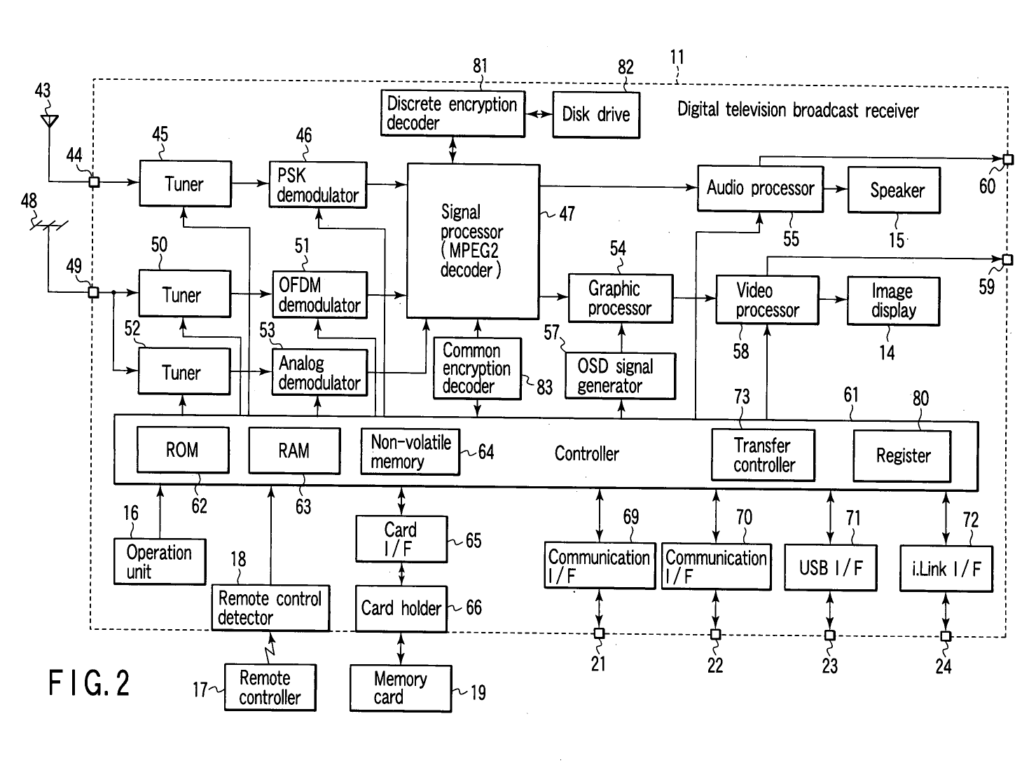

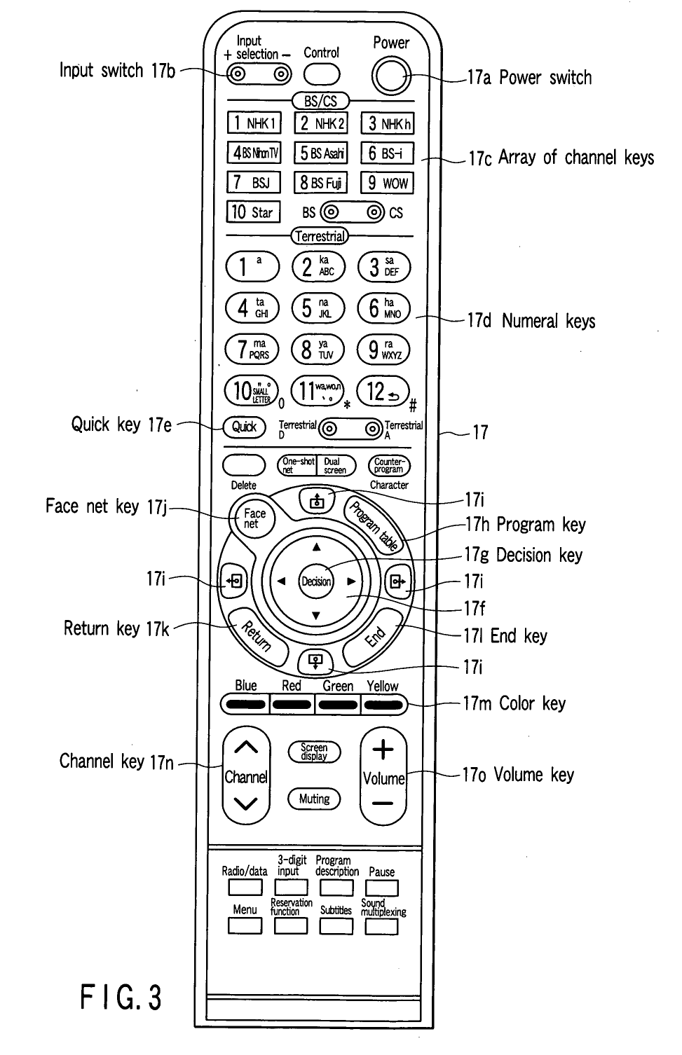

A television receiver equipped with a network function as a communication apparatus according to the present invention will be described referring to the drawings. FIG. 2 is a block diagram of a digital television broadcast receiver according to one embodiment of the present invention. FIG. 3 is a block diagram of a remote controller for the digital television broadcast receiver according to one embodiment of the present invention.

A digital television broadcast receiver 11 consists mainly of a thin type cabinet 12 and a support base 13 which supports the cabinet 12 upright. The cabinet 12 includes a flat-panel display 14 such as a liquid crystal display panel, a speaker 15, an operation unit 16, and a remote control detector 18 which receives operation information from a remote controller 17.

The digital television broadcast receiver 11 is arranged to have a memory card 19 detachably loaded thereon, such as a secure digital (SD) memory card, a multimedia card (MMC), or a memory stick. The memory card 19 may be an IC card in which a contract information is saved. This allows the receiver to record and reproduce a variety of information including TV programs and photographs on the memory card 19.

The digital television broadcast receiver 11 includes a first local area network (LAN) port 21, a second LAN port 22, a universal serial bus (USB) port 23, and an i.Link port 24.

The first LAN port 21 is provided as an LAN specific HDD dedicated port used for recording and reproducing information on a LAN specific HDD 25 as a network attached storage (NAS) over the Ethernet (registered trademark).

Since the first LAN port 21 serves as the LAN specific HDD dedicated port, it allows the HDD 25 to be operated for recording of the program information at high-definition TV quality regardless of the conditions of the network environment and the busyness of the network.

Also, the second LAN port 22 is provided as a common LAN specific port over the Ethernet. For example, the second LAN port 22 may be connected via a hub 26 with a LAN specific HDD 27, a personal computer (PC) 28, and an HDD built-in digital versatile disk (DVD) recorder 29 for exchanging information with each other.

Since the DVD recorder 29 receives substantially a digital information of control information from the second LAN port 22, a dedicated analog signal transmission path 30 is needed between the DVD recover 29 and the digital television broadcast receiver 11 for transmission of analog video and audio information.

The second LAN port 22 may be connected via a combination of the hub 26 and a broadband router 31 with a network 32, such as the Internet, for exchanging information with a PC 33 or a mobile phone 34 over the network 32.

The USB port 23 is provided as a common USB specific port. For example, the USB port 23 may be connected via a hub 35 with USB devices such as a mobile phone 36, a digital camera 37, a card reader/writer 38 for the memory card, an HDD 39, a keyboard 40 for exchanging information with these devices.

The i.Link port 42 is provided for serial connection with, e.g., an AV-HDD 41, a D-VHS (digital video home system) 42 for exchanging information with these devices.

FIG. 2 illustrates a main signal processing system in the above-described digital television broadcast receiver 11. Specifically, a digital satellite television broadcast signal received by a digital BS/CS broadcast signal antenna 43 is transferred via an input port 44 to a digital satellite broadcast tuner 45 where it is tuned to selectively pick up a broadcast signal of a desired channel.

The broadcast signal selectively picked up by the tuner 45 is then transferred to a phase key shifting (PSK) demodulator 46 where it is demodulated to a digital video signal and a digital audio signal which are then outputted a signal processor 47.

A digital terrestrial television broadcast signal received by a terrestrial broadcast receiving antenna 48 is transferred via an input port 49 to a digital terrestrial broadcast tuner 50 where it is tuned to selectively pick up a broadcast signal of a desired channel.

The broadcast signal selectively picked up by the tuner 50 is then transferred to an orthogonal frequency division multiplexing (OFDM) demodulator 51 where it is demodulated to a digital video signal and a digital audio signal which are then outputted to the signal processor 47.

An analog terrestrial television broadcast signal received by the terrestrial broadcast receiving antenna 48 is transferred via the input port 49 to an analog terrestrial broadcast tuner 52 where it is tuned to selectively pick up a broadcast signal of a desired channel. The broadcast signal selectively picked up by the tuner 52 is transferred to an analog demodulator 53 where it is demodulated to an analog video signal and an analog audio signal which are outputted to the signal processor 47.

The signal processor 47 is provided for selectively subjecting the video signal and the audio signal received from the PSK demodulator 46 and the OFDM demodulator 51 respectively to predetermined digital signal processing, such as MPEG2 decoding, and then transferring them to a graphic processor 54 and an audio processor 55.

The graphic processor 54 is has a function of superimposing an OSD (on-screen display) signal received from an OSD signal generator 57 over the digital video signal received from the signal processor 47. The graphic processor 54 is also arranged to selectively output the video output signal of the signal processor 47 and the OSD output signal of the OSD signal generator 57 or output both the output signals for simultaneously displaying two separate images on the screen.

The digital video signal outputted from the graphic processor 54 is supplied to a video processor 58. The video processor 58 is provided for converting the input digital video signal into an analog video signal of the format displayable on the image display 14. The analog video signal is further outputted to the image display 14 for displaying its image and via an output port 59 to the outside.

The audio processor 55 is provided for converting the input digital audio signal into an analog audio signal of the format reproducible with the speaker 15. The analog audio signal is then outputted to the speaker 15 for reproducing its sound and via an output port 60 to the outside.

All the operations of the digital television broadcast receiver 11 including the above-described receiving operations are entirely controlled by a controller 61. The controller 61 is equipped with a built-in central processing unit (CPU) for controlling the operation of each component in response to operation information received from the operation unit 16 or from the remote controller 17 via the remote control detector 18.

The controller 61 mainly includes a read only memory (ROM) 62 where control programs to be conducted by the CPU are stored, a random access memory (RAM) 63 for providing a working area for the CPU, and a non-volatile memory 64 where various setting and control information are stored.

The controller 61 is connected via a card I/F (port) 65 to a card holder 66 on which the memory card 19 can detachably be loaded. This allows the controller 61 to exchange information via the card I/F 65 with the memory card 19 loaded on the card holder 66. The controller 61 is also connected via another card I/F and another card holder, both not shown, to a second memory card (not shown) which can detachably be loaded. This allows the controller 61 to exchange information with the second memory card.

The controller 61 is further connected via a communication I/F 69 to the first LAN port 21. This allows the controller 61 to exchange information via the communication I/F 69 with the LAN specific HDD 25 connected to the first LAN port 21. In this case, the controller 61 includes a dynamic host configuration protocol (DHCP) server function for assigning and controlling the LAN specific HDD 25 connected to the first LAN port 21 with an Internet protocol (IP) address.

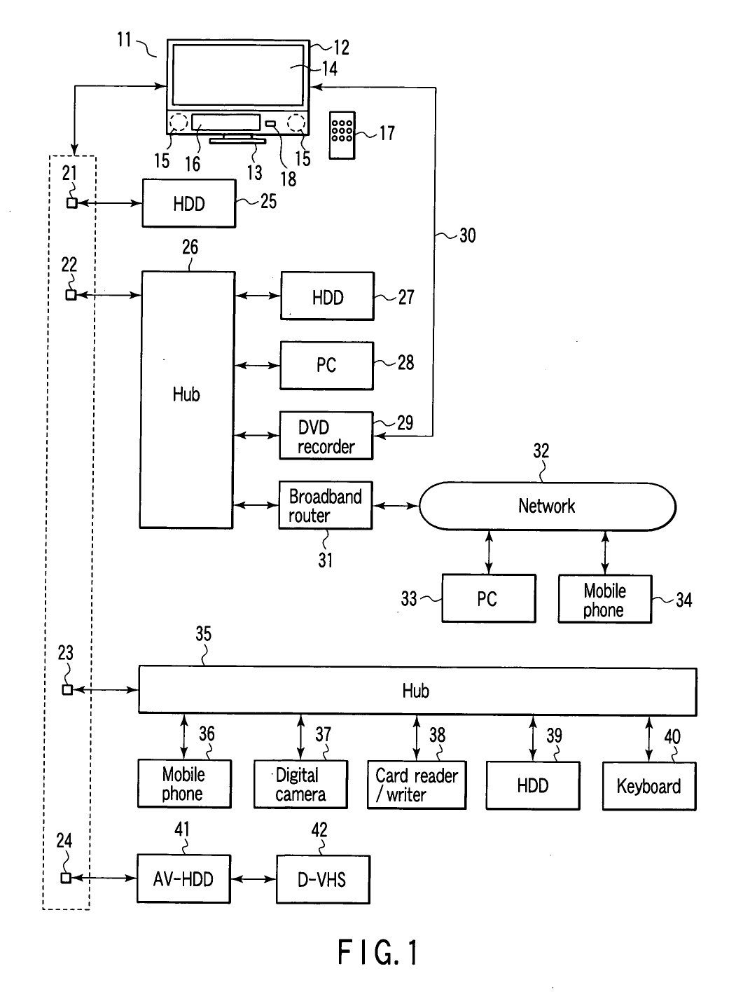

The controller 61 is further connected via another communication I/F 70 to the second LAN port 22. This allows the controller 61 to exchange information via the communication I/F 70 with each device (see FIG. 1) connected to the second LAN port 22.

The controller 61 is further connected via a USB I/F 71 to the USB port 23. This allows the controller 61 to exchange information via the USB I/F 71 with each device (see FIG. 1) connected to the USB port 23.

The controller 61 is further connected via an i.Link port 72 to the i.Link port 24. This allows the controller 61 to exchange information via the i.Link I/F 72 with each device (see FIG. 1) connected to the i.Link port 24.

The receiver 11 further includes a transfer controller 73 which controls the transfer of video and audio signals, a discrete encryption decoder 81 which encrypts the video and audio signals received from the signal processor 47 with the use of a discrete key, and a disk drive 82, such as a hard disk drive, which receives an output of the discrete encryption decoder 81. Alternatively, the disk drive 82 may preferably be a large-scale memory or any other information storage region. The controller 61 also includes a register 80 which registers a recording/reproducing apparatus over the network to which the contents information transmitted from the digital television broadcast receiver 11 is stored.

FIG. 3 illustrates an external view of the remote controller 17. The remote controller 17 comprises mainly a power key 17a, an input switch key 17b, an array of digital satellite broadcast channel direct access keys 17c, an array of terrestrial broadcast channel direct access keys 17d, a quick key 17e, a cursor key 17f, a decision key 17g, a program list key 17h, page switch keys 17i, a face net (navigation) key 17j, a return key 17k, an end key 17l, color keys 17m of blue, red, green, and yellow, a channel up/down key 17n, a volume adjusting key 17o, and a menu key 17p.

<Encryption Decoding Process Depending on Type of Storage>

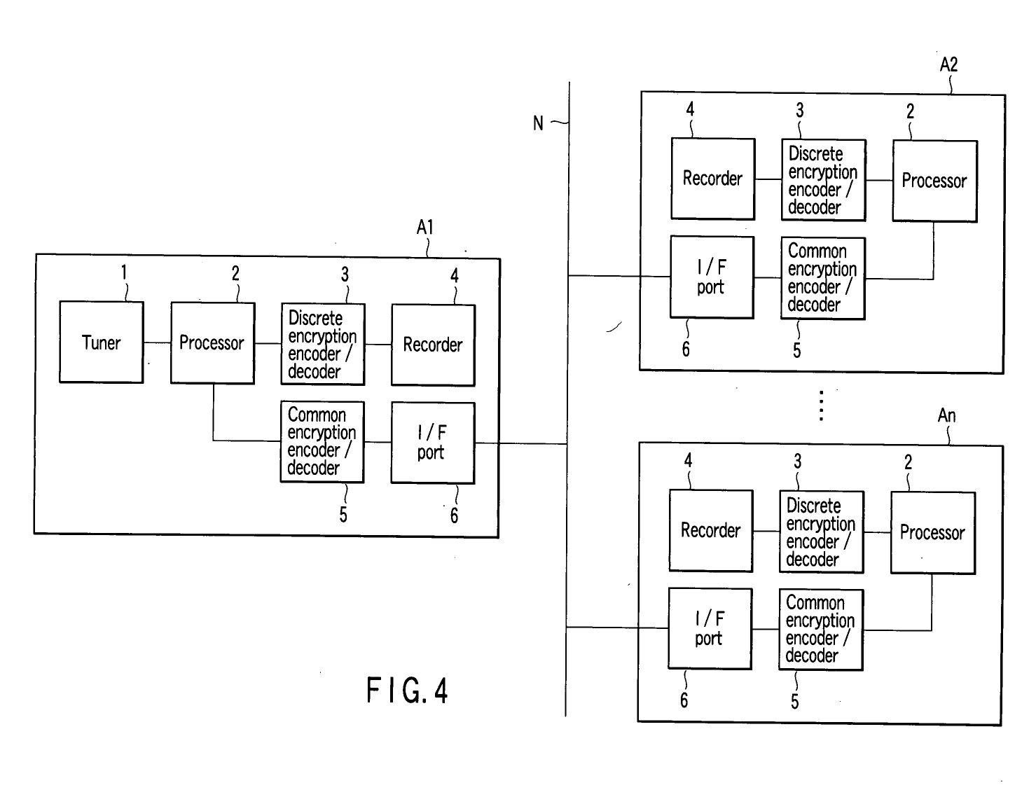

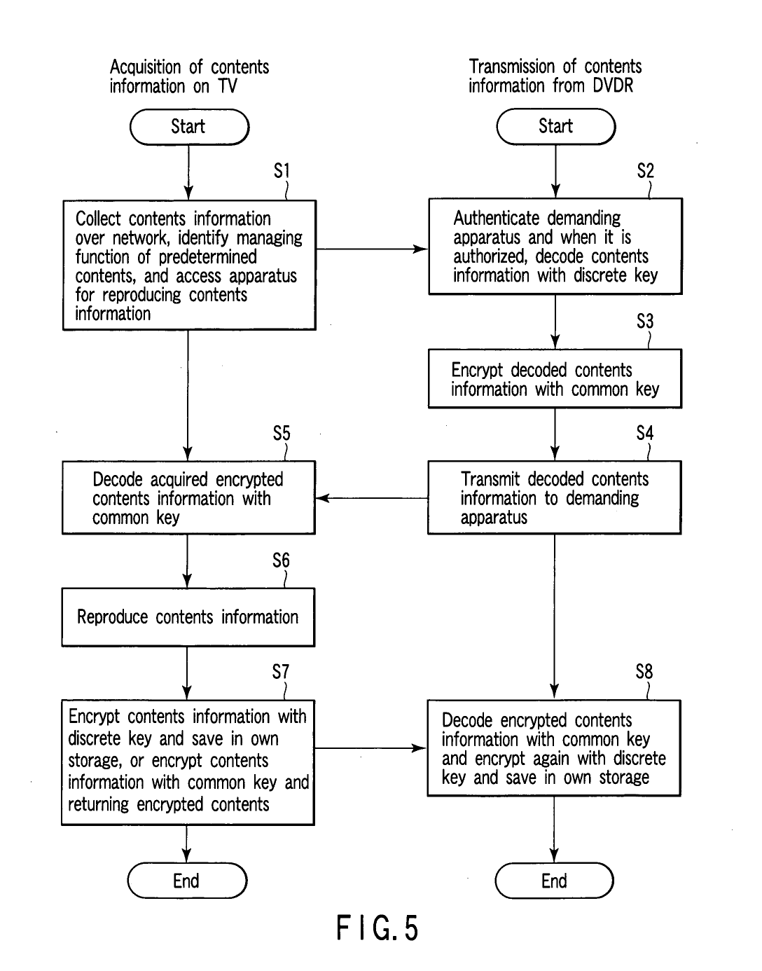

The process of encryption decoding in the digital television broadcast receiver depending on the type of a storage will now be described referring to a flowchart shown in FIG. 4. FIG. 4 illustrates a network diagram showing one feature of the digital television broadcast receiver according to one embodiment of the present invention. FIG. 5 is a flowchart showing an example of the encryption decoding process of the digital television broadcast receiver according to one embodiment of the present invention.

A processor 2 in the digital television broadcast receiver of the present invention shown in FIG. 4 as denoted by A1 is arranged for allowing the contents information received from a tuner 1 to be encrypted by a discrete encoder 3 using a discrete key before stored in a built-in storage 4. When the contents are demanded by another apparatus A2 over the network to be stored and recorded, the encrypted contents are decoded with a first discrete key and encrypted again by a common encryption encoder 5 using a common key to the network. The encrypted contents are then supplied via an I/F port 6 to the network N and received by the apparatus A2. In turn, the apparatus A2 conducts the same process for decoding the encrypted contents information using the common key before reproduction.

As may not be reproduced by other apparatus connected to the network, the contents information saved in the network HDD is decoded and then encrypted with the use of a key which is compatible with the demanding apparatus before transferred to the communication path.

Since the process of information encryption with the use of a discrete key assigned to a particular apparatus and the process of information encryption with the use of a common key open to the network are carried out separately, the system allows the contents information shared by discrete apparatuses to be accessed over the network at higher convenience while being maintained for high security.

The operation of the television receiver equipped with the network function for reproducing a contents information received over the network by the above described security system will be described referring to the flowchart of FIG. 5. The operation starts with the digital television broadcast receiver 11, which demands for receiving the contents information over the network, recognizing the DVD recorder 29 shown in FIG. 1 as a contents information managing apparatus and conducting an access operation trying to reproduce the contents (S1). This is followed by the DVD recorder 29 examining the authentication of the demanding receiver 11. When it is judged that the demand is received from an authorized apparatus, the contents information is retrieved from the storage 4 and decoded by the discrete encryption decoder 3 using the discrete key (S2). (When it is judged that the demand is received from an unauthorized apparatus, the operation will be canceled and not continue.) Then, the contents information is encrypted again by the common encryption encoder 5 using the common key (S3). The encrypted contents information is transferred via the I/F port 6 to the demanding apparatus (S4).

When received in the demanding apparatus or digital television broadcast receiver 11, the encrypted contents information is decoded by a common encryption decoder 83 using the common key (S5). The contents information is thus reproduced by a combination operation of the signal processor 47, the audio processor 55, and the video processor 58 (S6). This is followed by the contents information being either encrypted by a discrete encryption encoder 81 using the discrete key and saved into a disk drive 82 (a hard disk drive or a memory) which is a built-in storage or encrypted by the common encryption encoder 83 and returned back to the DVD recorder 29 (S7). In the DVD recorder 29, the encrypted contents information is decoded by the common encryption decoder 5 and encrypted again by the discrete encryption encoder 3 using the discrete key before saved in the storage 2 (S8).

As set forth above, the broadcast receiving apparatus of the embodiment when provided in the form of a television receiver equipped with the network function allows a desired contents information, e.g., a television program, to be encrypted using a first discrete key and then saved in a hard disk drive or any other storage installed therein. When the contents information is demanded for transfer to another hard disk recorder or the like connected to the network, it is decoded using the first discrete key and then encrypted again by a second common key open to the network before transferred over the network interface to the hard disk recorder or the like as a storage on the network. This allows the contents information to be encrypted and decoded at a higher level of the security.

It would be understood that the present invention is embodied in various forms by those skilled in the art and also changes and modifications are made without departing from the scope of the present invention. The present invention may be applicable to any other system which has no inventive features. The present invention can thus cover a wider range of the application compatible with the disclosed principles and novel features thereof as is not limited to the foregoing embodiments.

What is claimed is:

1. A broadcast receiving apparatus comprising:
a tuner which receives broadcast signals and selectively outputs the received signal;
a demodulator which demodulates the received signal outputted from the tuner and outputs video and audio signals;
a first encryption decoder which encrypts or decodes the video and audio signals with the use of a first encryption key;
a recorder which records the video and audio signals encrypted in the first encryption decoder;
a second encryption decoder which encrypts or decodes the video and audio signals with the use of a second encryption key which is different from the first encryption key;
a communicator which performs communication to transmit the video and audio signals encrypted in the second encryption decoder to another recorder over a network; and
a controller which, when the video and audio signals received from the demodulator or the outside are recorded in the recorder, directs the video and audio signals to be encrypted with the first encryption decoder and recorded, when taken out, decodes the signals in the first encryption decoder to be outputted, and when the video and audio signals are transmitted via the communicator, directs the video and audio signals to be encrypted with the second encryption decoder and transferred to another recorder over the network.

2. The broadcast receiving apparatus according to claim 1, further comprising:
a register which registers the recorder over the network in which the communicator performs communication as a recorder in which the video and audio signals outputted from the demodulator are recorded, wherein
the controller is arranged to control the video and audio signals to be recorded in the recorder registered by the register using the communicator.

3. The broadcast receiving apparatus according to claim 1, further comprising:
an MPEG decoder which decodes the video and audio signals demodulated by the demodulator to MPEG forms which are then supplied to the first or second encryption decoder.

4. The broadcast receiving apparatus according to claim 1, wherein
the recorder is a hard disk or a memory.

5. The broadcast receiving apparatus according to claim 1, wherein
the communicator is arranged to transmit and receive the video and audio signals after the authentication of a receiver on the network has been achieved.

6. The broadcast receiving apparatus according to claim 1, wherein the communicator is at least one of LAN, USB, and i-Link systems.

7. A broadcast receiving method comprising the steps of:
receiving broadcast signals and selectively outputting the received signal;
demodulating the received signal and outputting video and audio signals;
encrypting the video and audio signals with the use of a first encryption key and recording the encrypted video and audio signals in a recording area of a broadcast receiving apparatus; and
allowing the video and audio signals to be read out from the recording area, decoded with the first encryption key, encrypted again with the use of a second encryption key which is different from the first encryption key, and transmitted to another recorder over a network.

8. The broadcast receiving method according to claim 7, further comprising:
a step of registering the recorder connected to the network for communication as a recorder in which the video and audio signals are to be recorded and controlling the operation of recording the video and audio signals in the recorder registered over the network.

9. The broadcast receiving method according to claim 7, further comprising:
a step of decoding the video and audio signals to MPEG forms which are then encrypted with the first or second encryption key.

10. The broadcast receiving method according to claim 7, wherein the recording area is a hard disk or a memory.

11. The broadcast receiving method according to claim 7, further comprising:
a step of transmitting and receiving the video and audio signals after the authentication of a receiver on the network has been achieved.

12. The broadcast receiving method according to claim 7, wherein
the communication is carried out with at least one of LAN, USB, and i-Link protocols.
